(19) United States
(12) Patent Application Publication
(10) Pub. No.: US 2003/0187689 A1
(43) Pub. Date: Oct. 2, 2003

(54) Method and apparatus for a single database engine driven, configurable RIS-PACS functionality

(76) Inventors: Robert D. Barnes, Palatine, IL (US); Yongjian Bao, Vernon Hills, IL (US); Prakash Parayil Mathew, Wheaton, IL (US); Annamarie Hendrickx, Northbrook, IL (US); Kalpesh S. Patel, Palatine, IL (US); Roland Lamer, Evanston, IL (US); Atulkishen Venkatesh Setlur, Chicago, IL (US); Todd Lomaro, Algonquin, IL (US); Balaji Krishnamurthy, Prospect Heights, IL (US); Steven Bradley Taves, Arlington Heights, IL (US); Robert Scott Grant, West Dundee, IL (US)

Correspondence Address: MCANDREWS HELD & MALLOY, LTD, 500 WEST MADISON STREET, SUITE 3400, CHICAGO, IL, 60661

(21) Appl. No.: 10/063,180

(22) Filed: Mar. 28, 2002

(51) Int. Cl. G06F 17/60

(52) U.S. Cl. 705/2

(57) ABSTRACT

A method and apparatus are disclosed for providing fully integrated information processing, management and communication functions in a fully integrated RIS-PACS system for a radiology department/healthcare environment by employing brokerless interface methods to synchronize patient and exam data entities in a radiology information system (RIS) database and a picture archive and communication system (PACS) database within the RIS-PACS system and to generate direct database calls to the RIS and PACS databases. The running of RIS and PACS applications within the RIS-PACS system is initiated from client workstations over a web interface. Information from the databases is accessed by the client workstations. Also, the system may communicate between internal PACS applications and an external RIS system over a HL7-based interface or between internal RIS applications and an external PACS system over a standard medical communications interface such as HL7 and DICOM.

### BACKGROUND OF INVENTION

Certain embodiments of the present invention relate to electronic communications in a medical setting. More particularly, certain embodiments relate to a method and apparatus for providing fully integrated information processing, management and communication functions in a radiology/healthcare environment.

PACS (Picture Archive and Communication System) is an image management system typically used within Radiology departments of a hospital or other healthcare enterprise. PACS systems handle the details of imaging related tasks within the department such as acquisitions, display, manipulation, archiving, etc., to aid in the diagnostic capability of the department. In addition, Radiology departments need to manage and schedule the fulfillment and disposition of radiology orders. Functions of this type are typically performed by a RIS (Radiology Information System) by primarily managing the business and execution of workflow within the department. Conventionally, PACS and RIS are deployed as separate products, often from different vendors and may even be installed at different times.

However, both product functionalities are intimately related and, from the diagnosing radiologist's perspective, there is no merit in drawing a clear boundary between PACS and RIS. Radiologists actually derive more benefit from a seamless integration of RIS and PACS in terms of functionality and performance. Acknowledging this need, there have been numerous examples of RIS-PACS integration in the field. But all of these examples have been custom software efforts between different vendors, usually resulting in a clumsy interface between the systems requiring a broker and entailing high maintenance costs. Typically, users must log into and learn two applications and then swivel between workstations to see all of the data.

For example, a method described in U.S. Pat. No. 5,835,735 to Mason and Criswell describes a process that negotiates between applications operating in a PACS such that each application sends and receives data and messages in accordance with each application's stated functional conformance claim. Theoretically, some of the applications may be RIS-like applications. The functional attributes of each application are declared in a conformance claim. U.S. Pat. No. 6,076,166 to Moshfeghi, et al. describes a server having a layer for dynamically generating web pages and other data objects using scripts. Computer based patient record (CPR) information is distributed in the CPR databases of several systems such as PACS and RIS. The scripts generate dynamic server web pages and a web server sends back the dynamic web pages to a client web browser.

It may seem that a single RIS-PACS solution is the obvious answer. In principle, that is the case, however, reality dictates that many sites do not want to replace both RIS and PACS systems at the same time. The sites want to typically replace one of the systems while still using the historical records stored in the other system. Having replaced one system, sites would like the option of replacing the other system at a later time, with the minimum amount of downtime and expense. As a result, the problem becomes not just the lack of having a truly integrated RIS-PACS system, but having a system that is easily configurable to operate in any one of three modes including RIS only, PACS only, or fully integrated RIS-PACS.

A need exists to be able to provide fully integrated information processing, management and communication functions in a radiology department/healthcare environment without requiring a broker between a RIS and PACS. A need also exists to be able to provide a system that is easily configurable to operate in any one of three modes including RIS only, PACS only, or fully integrated RIS-PACS.

### SUMMARY OF INVENTION

An embodiment of the present invention provides for a RIS-PACS system providing fully integrated information processing, management and communication functions for a radiology department/healthcare environment. The RIS-PACS system includes a database server. The database server includes a RIS database, a PACS database, and a single database engine providing a brokerless interface between the RIS database and the PACS database. The system further includes an application server hosting a set of RIS and PACS applications and interfacing to the database server over a TCP/IP protocol-based interface. There is also at least one image server interfacing to the database server over at least one TCP/IP protocol-based interface providing access to image data from the image server. Client workstations interface to the application server over Web-based interfaces to provide access to the databases. The RIS-PACS system may also interface over a Health Level Seven (HL7)-based interface or a Digital Imaging Communications in Medicine (DICOM) interface providing communication between an external RIS or PACS system and the internal PACS or RIS applications.

Apparatus is provided for providing fully integrated information processing, management and communication functions in a radiology department/healthcare environment. The apparatus includes a database server with a radiology information system (RIS) database and a picture archive and communication system (PACS) database residing on the database server and being managed by a single database engine. The database engine provides a brokerless interface between the RIS database and the PACS database to provide data synchronization between the two databases. The apparatus further includes a set of RIS and PACS application modules and an application server running at least a subset of the set of RIS and PACS application modules. External RIS and PACS systems may also be interfaced to the apparatus for departments with previously installed RIS or PACS systems.

A method is also provided for fully integrating information processing, management and communication functions in a fully integrated RIS-PACS system for a radiology department/healthcare environment. The method includes synchronizing patient and exam data entities in a RIS database and a PACS database within the RIS-PACS system and generating direct database calls to the RIS and PACS databases using brokerless interface methods. The method further includes running RIS applications and accessing image information from the PACS database in response to running the RIS applications. Similarly, the method includes running PACS applications and accessing patient/exam information from the RIS database in response to running the PACS applications. Interfacing to external RIS and PACS systems is also provided by the method.

Certain embodiments of the present invention afford an approach to fully integrate information processing, management and communication functions for a radiology department/healthcare environment without requiring a broker interface between a RIS database and a PACS database. Certain embodiments also provide the ability for multiple configurations to accommodate transitions from installed-base configurations.

### BRIEF DESCRIPTION OF DRAWINGS

FIG. 1 is a schematic block diagram of a fully integrated RIS-PACS system formed in accordance with an embodiment of the present invention.

FIG. 2 is a schematic block diagram of a diagnostic configuration for the RIS-PACS system of FIG. 1, formed in accordance with an embodiment of the present invention, for interfacing to an external RIS system.

FIG. 3 is a schematic block diagram of a diagnostic configuration for the RIS-PACS system of FIG. 1, formed in accordance with an embodiment of the present invention, for interfacing to an external PACS system.

The foregoing summary, as well as the following detailed description of certain embodiments of the present invention, will be better understood when read in conjunction with the appended drawings. It should be understood, however, that the present invention is not limited to the arrangements and instrumentality shown in the attached drawings.

### DETAILED DESCRIPTION

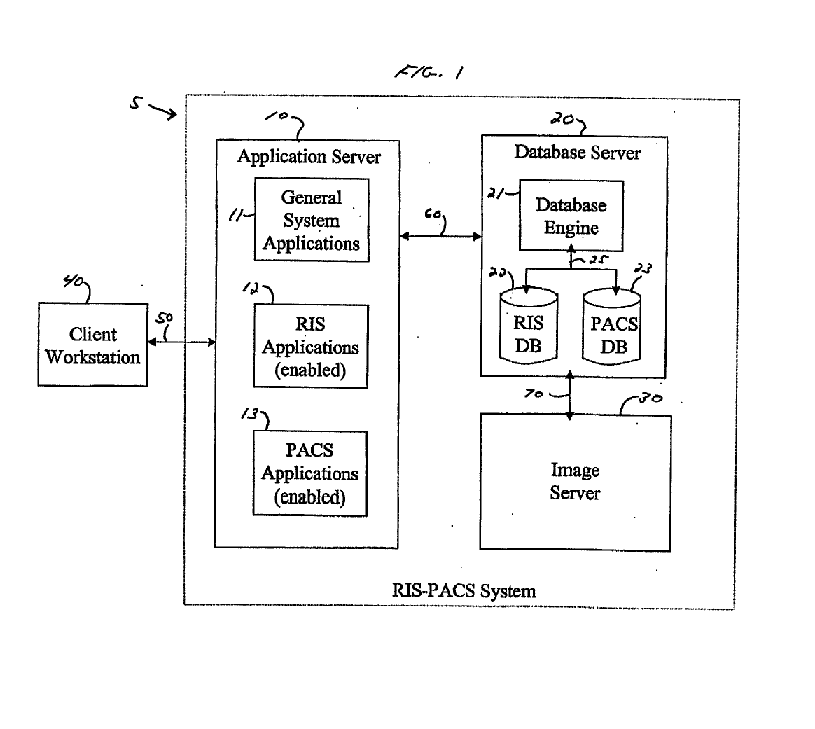

FIG. 1 is a schematic block diagram of the fully integrated RIS-PACS system 5 showing certain elements of the system 5 in accordance with one embodiment of the present invention. The RIS-PACS system 5 comprises an application server 10, a database server 20, and an image server 30. The application server 10 includes a set of general system applications modules 11, a set of RIS applications modules 12, and a set of PACS applications modules 13. The database server 20 includes a database engine 21, a RIS database 22, and a PACS database 23. The various servers, databases, and modules may be combined or separated according to various embodiments of the present invention. In one embodiment of the present invention, the application server 10, database server 20, and image server 30 are all hosted on a SUN E420 platform running the Solaris 8.0 operating system. Additional image servers 30 and platforms may be added to the system 5 as needed.

Application server 10 also functions as a web server and interfaces to at least one client workstation 40 over a web interface 50. Client workstation 40 typically comprises a processor, a web browser, network software, a keyboard, a mouse, and a monitor (not shown). The application server uses JSP (Java Server Page) technology to communicate with the client workstation 40 over the web interface 50. JSP technology is an extension to the Java servlet technology from SUN that provides a simple programming vehicle for displaying dynamic content on a Web page. A JSP is an HTML (HyperText Markup Language) page with embedded Java source code that is executed in the server 10. HTML provides the page layout that will be returned to the web browser within the client workstation 40 and the Java code provides the processing, for example, to deliver a client request to a database and fill in the blank fields with the results.

A JSP is compiled into a servlet when first encountered by the server 10. A Java servlet is a Java application that runs in a server-based system and provides server-side processing, typically to access information or initiate processing. Java servlets are supported on most platforms including unix based platforms and windows based platforms. A JSP may also call Enterprise JavaBeans (EJBs) for additional processing. An EJB is a component software architecture from SUN that is used to build Java applications that run in a server. The architecture uses a container layer that provides common functions such as security and transaction support and delivers a consistent interface to the applications regardless of the type of server.

Application server 10 is an EJB server providing a middle-tier architecture between client workstation 40 and database server 20. Application server 10 hosts a set of middle-tier applications including a set of general system applications 11, a set of RIS-related applications 12, and a set of PACS-related applications 13. A web server typically comprises a computer running standard server software so as to establish a standard HyperText Transport Protocol (HTTP) server within a system (e.g. the RIS-PACS system 5) that is able to connect to a network (e.g. the Internet). The server also typically comprises a set of JSP and/or HTML menus and Java applets to facilitate communication with a client (e.g. a client workstation 40). A Java applet is a Java program that is downloaded from the server and run from the web browser in the client workstation. Java servlets and applets are more flexible than, for example, CGI scripts and are portable between platforms, servers, and operating systems.

Communications between a client workstation 40 and an application server 10 may be made secure. For a standalone Java client, JSEE (Java Secure Sockets Extension) is used to transmit secure requests to the server 10. For web-based applications, a SSL (Secure Sockets Layer) enabled browser is used to encrypt requests from the client to the server.

In general, a web server provides WWW (world wide web) services on the Internet. A web server includes the hardware, operating system, web server software, TCP/IP protocols and web site content. The web server software refers to the HTTP server that manages web page requests from a browser and delivers JSP or HTML documents (web pages) in response. The server also executes server-side scripts that provide functions such as data base searching. HTTP is the communications protocol used to connect to web servers on the WWW. The primary function of HTTP is to establish a connection with a web server and transmit web pages to the client web browser. HTTPS (HyperText Transport Protocol Secure) is the protocol for accessing a secure web server. HTTPS directs the message to a secure port number.

The web interface 50 comprises the physical interface and software between the RIS-PACS system 5 and the client workstation 40. The client workstation 40 may be located in an office of a radiology department or at the home of a physician, for example. The web interface 50 may include telephone lines, routers and switchers, fiber optic cable, radio transmitters and receivers, or any other devices and software that may be used to establish a communications link between the RIS-PACS system 5 and client workstation 40. Typically, the web interface 50 comprises the Internet and the WWW. In general, a web browser is a program that serves as a front-end to the WWW on the Internet. The web browser allows a user to view a site on the WWW.

The web interface 50 provides the communication link between the application server 10 within the RIS-PACS system and the client workstation 40. Within the client workstation 40, a processor employs a web browser and network software. The processor also interfaces to a keyboard, a mouse, and monitor. The client workstation 40 initiates execution of software applications internal to the application server 10 in response to user inputs from a keyboard and mouse, and displays resultant RIS and PACS information on the monitor of the client workstation 40. In one embodiment of the present invention, certain RIS and/or PACS applications are hosted somewhere other than on the application server 10 such that the application server 10 has access to the certain RIS and/or PACS applications, for example, via other interfaces to other servers.

Information is formatted and transferred across a network interface using software controlled communications protocols such as TCP/IP (Transmission Control Protocol/Internet Protocol). The IP protocol controls the routing of information through the network interface and the TCP protocol controls the actual transfer of information (packets) over the network.

When information is to be sent from the RIS-PACS system 5 to a client workstation 40, the application server 10 employs the TCP/IP protocols to encapsulate the information into TCP packets. The TCP packets have header information that is used to track, check, and order the packets in the correct sequence for transmission. A given block of data comprises many packets and the packets may be routed differently over a network through different gateways. A gateway is a specialized computer used to connect and route packets of information between networks. The TCP protocol assures that the TCP packets are delivered to the correct destination in the correct order and without error.

Before transmission, the IP protocol is employed by the application server 10 to form IP packets from the TCP packets and having IP headers that provide addressing information that is used by the gateways to properly route the packets to their receiving destination. An IP header includes the Internet addresses of the source and destination. The IP protocol makes a best attempt to deliver all the packets but does not guarantee delivery.

At the receiving destination, (e.g. client workstation 40) the TCP packets are checked for errors according to the header information. Packets that are free of errors are acknowledged by the receiving destination and are placed in correct order to be reassembled into the original block of data. The transmitting source keeps track of packet acknowledgements. If a packet is not acknowledged in a certain amount of time, the packet is resent by the source (e.g. system 5). The receiving destination holds all received packets until all packets that make up the data block have been acknowledged. The packets are then correctly ordered and reassembled at the receiving destination.

TCP/IP is configured for the RIS-PACS system 5 and the network environment to which the system 5 is connected. For example, typical configuration information that is provided for TCP/IP comprises the user name and password associated with the system 5, the server address of the system 5, the IP address of the system 5, the type of local network the system may be connected to, and addresses of other systems on the local network.

The application server 10 in the RIS-PACS system is an HTTP server that interacts with the protocols (TCP/IP). The application server 10 is configured to communicate with a standard web browser of a client workstation 40. The web browser provides client requests to the application server 10 in order to initiate RIS and/or PACS applications and access RIS and/or PACS information from the RIS-PACS system 5. The application server 10 responds to the client requests by providing web pages of information and hypertext connections that are displayed to the user on the client workstation 40.

The application server 10 is configured for such things as security by, for example, limiting access to certain users. Configuration information is stored in configuration files of the application server 10. Configuration files of the application server 10 may identify ports used by the application server 10 and, for example, the server administrator. The location of files used by the application server 10 are also included in the configuration files. The configuration files may also include the addresses of web pages and Java applets and servlets used by the application server 10.

In response to client requests by, for example, client workstation 40, the application server 10 transmits JSP pages to the web browser of the client workstation 40. The JSP pages encapsulate what the web browser may display on the monitor of client workstation 40. The displayed information may include text, images, buttons, etc. JSP pages are easily created using standard software tools. The JSP pages are stored on the RIS-PACS system and the addresses of the JSP pages are configured in the application server 10. When a client workstation (e.g. 40) requests to view a specific RIS-PACS web page of the system, the application server 10 finds the page and transmits its contents to the client workstation 40 over the web interface 50. The processor in the client workstation 40 executes the web browser to access the web interface through TCP/IP protocols configured for the client workstation 40.

Within the RIS-PACS system 5, the application server 10 communicates with the database server 20 over a TCP/IP-based interface 60 and the database server 20 communicates with the image server 30 over a TCP/IP-based interface 70. Image data is stored in the image server 30. The PACS database 23 points to image files within the image server 30 to access image data over the TCP/IP-based interface 70. The application server 10 accesses both RIS and PACS information from the database server 20 through the TCP/IP-based interface 60.

The database server 20 searches the RIS and PACS databases for selected records upon request from the application server 10 and passes the records back to the application server 10. Within the database server 20, a brokerless interface 25 is provided by the database engine 21 to synchronize patient and exam data entities between the RIS database and PACS database and to direct database calls. Since RIS and PACS functions are fully integrated in the system 5, a separate broker is not needed as when RIS and PACS are two separate systems.

A broker is a separate workflow manager used to achieve a higher level of integration between a RIS system and a PACS system. A broker typically translates Health Level Seven (HL7) information from a RIS system to a format that a PACS system may understand. The brokerless interface 25 serves to provide seamless integration when accessing RIS and PACS information, making RIS/PACS workflow more efficient and increasing productivity. Image information may be accessed from the PACS database 23 in response to a RIS application and patient/exam information may be accessed from the RIS database 22 in response to a PACS application. Also, when a patient record is created in the RIS database, a corresponding new patient record is automatically created in the PACS database. Brokerless interface (BLI) methods are used to achieve the seamless integration. The BLI methods allow RIS and PACS functions to directly access each other at the database level.

In one embodiment of the present invention, both the RIS and PACS databases are configured in the Veritas File System partitions, accessed with the Veritas QuickIO application programming interface (API). In one embodiment of the present invention, both the PACS database and RIS database schemas run under the Sybase Adaptive Server Enterprise (ASE) 12 database engines, version 12, in all system deployment modes.

Some of the middle-tier applications provided by the application server 10 include an administration module and a reporting module. The administration module provides system administration and configuration functions within the RIS-PACS system 5. Some administration module functions include changing implemental configurations of the RIS-PACS system 5, adding a new user to the RIS-PACS system 5, and changing procedure types to be performed by the RIS-PACS system 5. Also, users may define RIS and PACS data entities to be synchronized automatically by the administration module. The synchronized data entities are populated in both RIS and PACS databases.

The reporting module is dedicated to the management of diagnostic report functions. Some examples of diagnostic report functions include creating diagnostic reports in a structured report (SR) format, merging diagnostic reports, amending diagnostic reports, and approving diagnostic reports. Also, installed base (IB) reports may be converted to the structured report (SR) format.

The reporting module allows for the storing of reports in DICOM SR compliant file format. The DICOM SR files may be read and converted to an XML format that is validated by an XML schema that ensures compliance with the DICOM SR TID2000 template. The reporting module is a web browser application that is used in integrated web environments and is integrated with the Java application based RIS/PACS system.

The reporting module stores references to key images, within an SR object, that are selected on the RIS/PACS system. Thumbnail images may be displayed for the key images when a corresponding report is displayed on the RIS/PACS system or on the web. The thumbnail images may be used to display the images at a larger size. The RIS reporting features are available with the same web graphical user interface on both the web and on the RIS/PACS system.

The reporting module makes available a sticky notes feature that allows for the adding of notes to a report that will be prompted to the next user that logs in, or set to persistently display the sticky note each time the report is displayed. The sticky note may be made a part of the clinical record or deleted. The reporting module also displays a flag for reports of the highest priority for immediate attention for report approval. The reporting module supports a report repository that may be queried from other systems using DICOM.

Other middle-tier applications provided by the application server 10 include a central logging module providing application logging and audit logging functions, and a central user login module providing user account management support to synchronize the user account in the RIS and PACS databases and to implement all password requirements for Health Insurance Portability and Accountability Act (HIPAA) compliance. Users are presented with a single access point, providing authentication and authorization of entry into both RIS and PACS applications when configured in the RIS-PACS configuration. The RIS or PACS databases may be used as a repository for the user names and passwords. Password strings are entered in an encrypted format. Typically, a servelet handles the incoming request to log in and activates an EJB that performs the database related operations for authentication and password updates. The architecture also lends itself to accommodate other segments of the hospital enterprise such as cardiology and pathology.

Further middle-tier applications include a patient scheduling module, enhanced display protocols for medical images, a mammography tracking module, and a patient ordering module.

The patient scheduling module is a software application module within the RIS-PACS system that schedules patients over the entire enterprise system. A hospital needs to be able to schedule patients in accordance with procedural rules for exams, equipment availability, personnel availability, and department availability. For example, a patient must be prepped within a specified period of time before the exam is actually performed. The prep work may involve equipment and personnel that need to be scheduled in addition to the needs of the exam. A proprietary language is used to allow a user to define the relationships between procedures. Relationships between procedures are predefined and an algorithm performs auto-scheduling of procedures for a patient based on the exam chosen for the patient and the facilities available to a patient. Conflict checking (for clinical resources, etc.) is performed as part of the scheduling process.

Enhanced display protocols for medical images are also provided as part of the RIS-PACS system. To reduce the amount of image manipulation performed by radiologists before they are able to read a set of images, DDPs (Default Display Protocols) are defined by a user and are saved as a DDP object in a database (such as the PACS database). The DDPs determine the image layout, image grouping and series matching for a type of modality, study procedure, a number of related exams, a login user, a number of display monitors, and connections for cross referencing and linking. Image presentation information stored in a DDP include tool settings such as window and level, zoom factor, image orientation, and gray scale inversion. The image presentation and link established on a monitor screen may be saved within a DDP object in the database. Users may define the study procedure that the saved DDP shall be applied to as a default. When a user opens an exam, the exam may be displayed in exactly the same layouts, image presentation, and series link as the hanging protocol defined for that exam's study procedure.

A mammography tracking module is a software application module that is also provided as part of the RIS-PACS system. The mammography tracking module stores data in the RIS and PACS databases for all mammography related procedures performed at the site. By law, sites that perform mammography screening or diagnostic mammography exams are required to present any and all findings to the referring doctor and patient within a specific period of time. The mammography tracking module keeps track of the notices that have been sent out and maintains all related records for auditing purposes. Administrators are also notified, by the mammography tracking module, of notifications that need to be sent out. A dashboard display is provided for letter generation and mailings, and for tracking mammography results, appointments, and follow up mailings according to FDA rules.

A patient ordering module is a software application module that is also provided as part of the RIS-PACS system. An exam may comprise multiple procedures that must be performed in a specific order and within a specific time frame. The order must also have the appropriate codes set up for billing. Tracking the patient based on the ordered procedures once the patient is in the examining facility is important to the safety of the patient and for smooth operation of the facility. The patient ordering module uses a proprietary language to set up relationships between procedures that must occur during an exam. The information is saved in the RIS database and/or PACS database and is recalled when a user is setting up an order for a patient. The database is periodically queried for patient information updates and a dashboard display is provided for all patient transactions to be viewed as they happen. The ordering dashboard provides an administrator with up to date information on the progress of the patient in the facility. The administrator is able to see at a glance which patients are approaching a time critical state for safe procedure execution. The procedure set up allows for relationships between multiple procedures to be established and tracked.

A visual user interface, called an integrated desktop environment (IDE), is provided by the application server 10 such that a unified and consistent look and feel is provided to a user of the client workstation 40 for both RIS and PACS applications. The RIS-PACS system 5 also shares the same master file data across all implemental configurations.

There are three system deployment modes or implemental configurations for the RIS-PACS system 5. The first configuration comprises enabling both RIS and PACS applications, providing a fully integrated RIS-PACS configuration. The second configuration comprises enabling a set of RIS applications and disabling a set of PACS applications within the RIS-PACS system and interfacing the RIS-PACS system to an external PACS system. The third configuration comprises enabling a set of PACS applications and disabling a set of RIS applications within the RIS-PACS system and interfacing the RIS-PACS system to an external RIS system.

In all of the deployment modes, the same core system servers are applied and certain integrated system services are always provided which provide the consistent system architecture for the client/middle-tier applications, independent of the particular deployment mode in use.

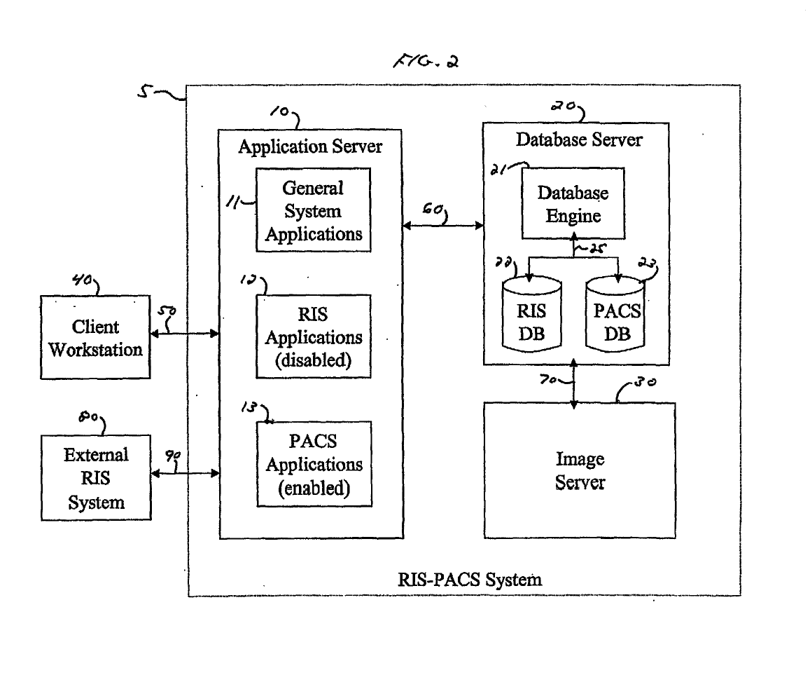

When a user already has a separate external RIS system 80 such as that shown in FIG. 2, the RIS-PACS system 5 may be configured to operate with the external RIS system 80. The internal set of RIS application modules 12 is disabled and the application server 10 interfaces to the external RIS system 80 over a Health Level Seven (HL7)-based interface 90 as shown in FIG. 2. As a result, the RIS-PACS system 5 provides the PACS functionality and the external RIS system 80 provides the RIS functionality. The TCP/IP-based interface 50 between the client workstation 40 and the application server 10 is unchanged. The RIS-PACS system 5 effectively integrates the functionality of the external RIS system 80 with the RIS-PACS system 5. The same visual user interface is provided by the application server 10 such that a unified and consistent look and feel is provided to a user of the client workstation 40 for both RIS and PACS applications.

HL7 is an international set of open standards for communication that allows health information systems that are developed independently to communicate with each other. HL7 is independent of technologies and platforms and may be implemented using a variety of software technologies. HL7 is the healthcare standard for text or RIS-type data.

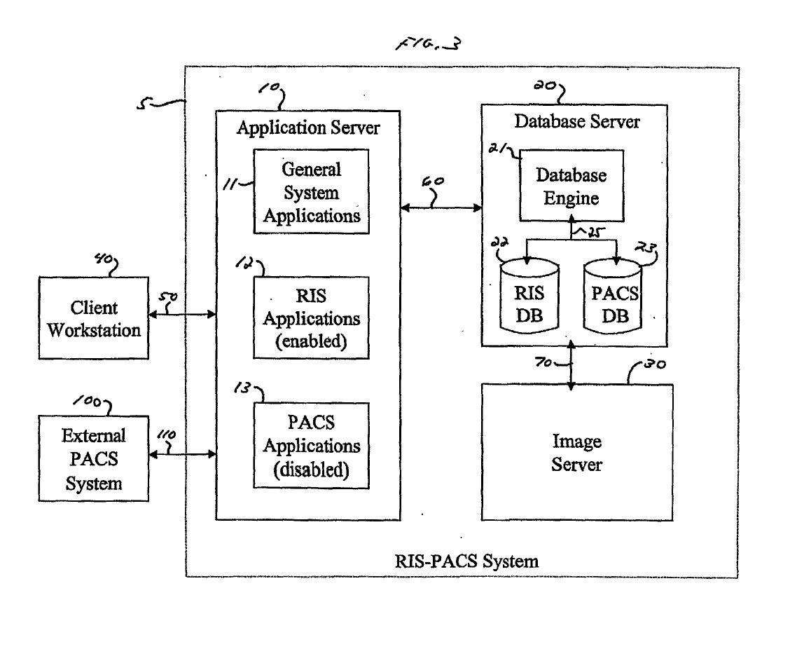

Similarly, when a user already has a separate external PACS system 100 such as that shown in FIG. 3, the RIS-PACS system 5 may be configured to operate with the external PACS system 100. The internal set of PACS application modules 13 is disabled and the application server 10 interfaces to the external PACS system 100 over a HL7-based interface or Digital Imaging Communications in Medicine (DICOM)-based interface 110 as shown in FIG. 3. As a result, the RIS-PACS system 5 provides the RIS functionality and the external PACS system 100 provides the PACS functionality. The TCP/IP-based interface 50 between the client workstation 40 and the application server 10 is unchanged. The RIS-PACS system 5 effectively integrates the functionality of the external PACS system 100 with the RIS-PACS system 5. Again, the same visual user interface is provided by the application server 10 such that a unified and consistent look and feel is provided to a user of the client workstation 40 for both RIS and PACS applications.

DICOM is the standard in the radiology and cardiology imaging industry for the exchange and management of images and image related information between health systems that are developed independently of each other. DICOM is the healthcare standard for imaging data.

In any deployment mode and any system configuration, there is one database server 20 to serve all PACS and/or RIS applications in the system 5. One or more image servers 30 may be installed.

As an alternative, the RIS database 22 and the PACS database 23 may be implemented as a single database.

In summary, the advantages and features include, among others, a single product design that may be used to satisfy three different markets that cover most customer configurations. A single radiology workflow engine is used to address the traditional problems of data synchronization and workflow competition between the RIS and PACS. The market segment for product entry penetration has been effectively widened. In the case of RIS-only or PACS-only configurations, the complementary functionality may be deployed with minimum effort since it involves simply a configuration change. No new development or installation is required and, therefore, the costs associated therein need not be incurred. Since upgrading the RIS-PACS functionality is only configurational, and the underlying product architecture and code is not changed, a user will notice inherently greater stability and performance.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. Apparatus for providing fully integrated information processing, management and communication functions in a radiology department/healthcare environment, said apparatus comprising:
a database server;
a radiology information system (RIS) database residing on said database server;
a picture archive and communication system (PACS) database residing on said database server; and
a database engine residing on said database server to manage said RIS database and said PACS database by providing a brokerless interface between said RIS database and said PACS database.

2. The apparatus of claim 1 further comprising:
a set of RIS application modules;
a set of PACS application modules; and
an application server running at least a subset of said set of RIS application modules and said set of PACS application modules.

3. The apparatus of claim 1 further comprising:
an application server; and
at least one Web connection interfacing said application server to at least one client workstation, said at least one client workstation being external to said apparatus.

4. The apparatus of claim 1 further comprising:
an application server; and
a TCP/IP protocol-based interface connecting said application server to said database server thus providing access to information from said database server.

5. The apparatus of claim 1 further comprising:
at least one image server storing image data; and
at least one TCP/IP protocol-based interface connecting said database server to said at least one image server thus providing access to said image data from said at least one image server.

6. The apparatus of claim 1 further comprising:
a set of RIS application modules that are disabled;
a set of PACS application modules that are enabled; and
a Health Level Seven (HL7)-based interface providing communication between said set of PACS application modules and a RIS system that is external to said apparatus.

7. The apparatus of claim 1 further comprising:
a set of PACS application modules that are disabled;
a set of RIS application modules that are enabled; and
a standard medical communications interface providing communication between said set of RIS application modules and a PACS system that is external to said apparatus.

8. The apparatus of claim 1 further comprising:
an application server, wherein said application server is an Enterprise JavaBeans (EJB)-based server;
a set of RIS application modules running on said application server; and
a set of PACS application modules running on said application server.

9. The apparatus of claim 1 further comprising:
an application server; and
a reporting module running on said application server and being dedicated to the management of diagnostic report functions.

10. The apparatus of claim 1 further comprising:
an application server; and
an administration module running on said application server and providing system administration and configuration functions.

11. The apparatus of claim 1 further comprising:
an application server; and
a central logging module running on said application server and providing application logging and audit logging functions.

12. The apparatus of claim 1 further comprising:
an application server; and
a central user login module running on said application server and providing central user account management support.

13. The apparatus of claim 1 further comprising:
an application server; and
a patient scheduling module running on said application server and providing automatic scheduling of procedures for patients based on clinical resources available to said patients.

14. The apparatus of claim 1 further comprising:
an application server; and
a set of default display protocols (DDPs) stored on said database server and applied to a set of medical images for reading said set of medical images in a pre-defined display format.

15. The apparatus of claim 1 further comprising:
an application server; and
a mammography tracking module running on said application server, said mammography tracking module storing mammography related information on said database server and keeping track of notices sent out and to be sent out to referring doctors and patients, and maintaining all mammography related records for auditing purposes.

16. The apparatus of claim 1 further comprising:
an application server; and
a patient ordering module running on said application server, said patient ordering module tracking a patient based on a set of ordered procedures as said patient progresses through said set of ordered procedures.

17. The apparatus of claim 1 further comprising a visual user interface providing a unified and consistent look and feel for both RIS and PACS applications.

18. A method for providing fully integrated information processing, management and communication functions in a fully integrated RIS-PACS system for a radiology department/healthcare environment, said method comprising:
synchronizing patient and exam data entities in a radiology information system (RIS) database and a picture archive and communication system (PACS) database within said RIS-PACS system using brokerless interface methods; and
generating direct database calls to said RIS database and said PACS database using said brokerless interface methods.

19. The method of claim 18 further comprising:
running at least one RIS application within said RIS-PACS system; and
accessing image information from said PACS database in response to said running of said at least one RIS application.

20. The method of claim 18 further comprising:
running at least one PACS application within said RIS-PACS system; and
accessing patient/exam information from said RIS database in response to said running of said at least one PACS application.

21. The method of claim 18 further comprising:
initiating the running of at least one RIS application and/or at least one PACS application within said RIS-PACS system from at least one client workstation over at least one Web interface; and
accessing information from said RIS database and/or said PACS database at said at least one client workstation over said at least one Web interface in response to said running of said at least one RIS application and/or said at least one PACS application.

22. The method of claim 18 further comprising:
disabling a set of RIS applications within said RIS-PACS system;
enabling a set of PACS applications within said RIS-PACS system; and
communicating between said set of PACS applications and an external RIS system over a HL7-based interface.

23. The method of claim 18 further comprising:
disabling a set of PACS applications within said RIS-PACS system;
enabling a set of RIS applications within said RIS-PACS system; and
communicating between said set of RIS applications and an external PACS system over a standard medical communications interface.

24. The method of claim 18 further comprising synchronizing master file data across implemental configurations of said RIS-PACS system, said implemental configurations comprising:
enabling a set of RIS applications and disabling a set of PACS applications within said RIS-PACS system;
enabling said set of PACS applications and disabling said set of RIS applications; and
enabling said set of RIS applications and said set of PACS applications.

25. The method of claim 18 further comprising presenting a user with a single access point for authentication and authorization of entry into both a set of RIS applications and a set of PACS applications within said RIS-PACS system when said set of RIS applications and said set of PACS applications are enabled.

26. The method of claim 18 further comprising:
creating diagnostic reports within said RIS-PACS system;
merging diagnostic reports within said RIS-PACS system;
amending diagnostic reports within said RIS-PACS system; and
approving diagnostic reports within said RIS-PACS system.

27. The method of claim 18 further comprising converting DICOM SR files to XML format for web-based use.

28. The method of claim 18 further comprising storing references to key images, within an SR object, that are selected on said RIS/PACS system.

29. The method of claim 18 further comprising displaying thumbnail images, corresponding to key images, within a report.

30. The method of claim 18 further comprising generating electronic sticky notes for a report.

31. The method of claim 18 further comprising flagging reports of highest priority.

32. The method of claim 18 further comprising supporting a report repository that may be queried from other systems that use DICOM.

33. The method of claim 18 further comprising:
changing an implemental configuration of said RIS-PACS system;
adding a new user to said RIS-PACS system; and
changing procedure types to be performed by said RIS-PACS system.

34. The method of claim 18 further comprising:
performing application logging functions within said RIS-PACS system; and
performing audit logging functions within said RIS-PACS system.

35. The method of claim 18 further comprising:
synchronizing user accounts in said RIS database and said PACS database; and
implementing password requirements for Health Insurance Portability and Accountability Act (HIPAA) compliance within said RIS-PACS system.

36. The method of claim 18 further comprising:
pre-defining a set of relationships between exam procedures;
storing said set of relationships on said RIS-PACS system; and
automatically scheduling at least a subset of said exam procedures for at least one patient based on said set of relationships and clinical resources available to said at least one patient.

37. The method of claim 18 further comprising:
defining a set of image display protocols for a set of medical images to be examined by a user;
storing said set of image display protocols on said RIS-PACS system in the form of default display protocol (DDP) objects; and
recalling said set of medical images for viewing by applying said DDP objects associated with said set of medical images.

38. The method of claim 18 further comprising:
entering and storing mammography related information in said RIS-PACS system from mammography related exams;
tracking mammography related notices sent out to and to be sent out to referring doctors and patients; and
maintaining mammography related records for auditing purposes.

39. The method of claim 18 further comprising:
pre-defining a set of relationships between procedures that occur during a patient exam;
storing said set of relationships in said RIS-PACS system;
ordering a set of procedures to be performed for at least one patient based on said set of relationships;
entering queried updates to said RIS-PACS system based on patient information during the performance of said set of procedures; and
tracking and billing said at least one patient through execution of said set of procedures in response to said queried updates to said RIS-PACS system.

40. The method of claim 18 further comprising providing a unified and consistent look and feel to a user within said RIS-PACS system for both a set of RIS applications and a set of PACS applications.

41. The method of claim 18 further comprising converting installed base (IB) reports to structured reports (SR) within said RIS-PACS system.

42. A RIS-PACS system providing fully integrated information processing, management and communication functions for a radiology department/healthcare environment, said RIS-PACS system comprising:
a database server, said database server including a RIS database, a PACS database, and a database engine providing a brokerless interface between said RIS database and said PACS database;
an application server hosting a set of RIS applications and a set of PACS applications and interfacing to said database server over a TCP/IP protocol-based interface;
at least one image server interfacing to said database server over at least one TCP/IP protocol-based interface providing access to image data from said at least one image server; and
at least one client workstation interfacing to said application server over at least one Web interface.

43. The RIS-PACS system of claim 42 further comprising a Health Level Seven (HL7)-based interface providing communication between said set of PACS applications and an external RIS system when said set of RIS applications are disabled.

44. The RIS-PACS system of claim 42 further comprising a standard medical communications interface providing communication between said set of RIS applications and an external PACS system when said set of PACS applications are disabled.

45. The RIS-PACS system of claim 42 wherein said at least one client workstation comprises a web browser.

46. The RIS-PACS system of claim 42 wherein said at least one client workstation is a standalone Java client.
